(19) United States
(12) Patent Application Publication
(10) Pub. No.: US 2024/0194206 A1
(43) Pub. Date: Jun. 13, 2024

(54) ELECTRONIC DEVICE FOR IDENTIFYING SYNTHETIC VOICE AND CONTROL METHOD THEREOF

(71) Applicant: SAMSUNG ELECTRONICS CO., LTD., Suwon-si (KR)

(72) Inventors: Oleksandra SOKOL, Kyiv (UA); Dmytro PROGONOV, Kyiv (UA); Heorhii NAUMENKO, Kyiv (UA); Kostiantyn VOLOBUIEV, Kyiv (UA); Vasyl KUZNETSOV, Kyiv (UA); Viacheslav DERKACH, Kyiv (UA)

(73) Assignee: SAMSUNG ELECTRONICS CO., LTD., Suwon-si (KR)

(21) Appl. No.: 18/438,225

(22) Filed: Feb. 9, 2024

Related U.S. Application Data
(63) Continuation of application No. PCT/KR23/19253, filed on Nov. 27, 2023.

(30) Foreign Application Priority Data
Dec. 13, 2022 (KR) 10-2022-0174206

(51) Int. Cl. G10L 17/26; G10L 17/02; G10L 17/04; G10L 17/06; G10L 25/63

(52) U.S. Cl. CPC G10L 17/26; G10L 17/02; G10L 17/04; G10L 17/06; G10L 25/63

(57) ABSTRACT

An electronic device includes a microphone, and at least one processor configured to, based on receiving voice data through the microphone, input the voice data into a non-semantic feature extractor model and acquire a non-semantic feature included in the voice data using the non-semantic feature extractor model, input the non-semantic feature into a synthetic voice classifier model and classify the voice data into a synthetic voice or a user voice the synthetic voice classifier model, and provide a result of the classification, and the synthetic voice classifier model is a model that is transfer-learned based on the non-semantic feature extractor model.

### CROSS-REFERENCE TO RELATED APPLICATION(S)

This application is a bypass continuation of International Application No. PCT/KR2023/019253, filed on Nov. 27, 2023, which is based on and claims priority to Korean Patent Application No. 10-2022-0174206, filed on Dec. 13, 2022, in the Korean Intellectual Property Office, the disclosures of which are incorporated by reference herein in their entireties.

### BACKGROUND

### 1. Field

The disclosure relates to an electronic device and a control method thereof, and more particularly, to an electronic device that classifies voice data into a synthetic voice or a user voice, and a control method thereof.

### 2. Description of Related Art

As development of artificial intelligence models is actively going on, artificial intelligence models having various purposes are being distributed.

As technologies related to artificial intelligence models have developed, fake voices (e.g., imitating voices) and fake images that look like real ones can be made, and accordingly, new legal problems that did not exist in the past are arising.

The word ‘deepfake’ which refers to fake voices and fake images generated by artificial intelligence models is a compound word of ‘deep learning’ and ‘fake,’ and it refers to voices, image, etc. that were manipulated to look like real ones. As there is a risk that such deepfake voices or deepfake images may be used for deceiving others maliciously, or they may be used in an authentication process related to security, there has been a demand for a device and a method for identifying whether a voice or an image is a fake one, i.e., a deepfake voice or a deepfake image generated by an artificial intelligence model.

Looking into damage cases related to voice phishing (vishing) that keep increasing recently, the ratio occupied by cases where deepfake voices generated by artificial intelligence models were used in the overall cases is gradually increasing, and thus there is an increasing demand for a technical method for identifying deepfake voices and preventing damage before occurring.

### SUMMARY

According to an embodiment of the disclosure, an electronic device includes a microphone, and at least one processor configured to, based on receiving voice data through the microphone, input the voice data into a non-semantic feature extractor model and acquire a non-semantic feature included in the voice data using the non-semantic feature extractor model, input the non-semantic feature into a synthetic voice classifier model and classify the voice data into a synthetic voice or a user voice using the synthetic voice classifier model, and provide a result of the classification, and the synthetic voice classifier model may a model that is transfer-learned based on the non-semantic feature extractor model.

The non-semantic feature comprises a feature vector corresponding to the voice data, and the at least one processor may be further configured to: acquire a first sample user voice and a second sample user voice among a plurality of sample user voices, acquire a first segmentation voice and a second segmentation voice from the first sample user voice, acquire a third segmentation voice from the second sample user voice, input each of the first to third segmentation voices into the non-semantic feature extractor model, and acquire first to third feature vectors corresponding to the first to third segmentation voices, acquire an emotion classification loss and a similarity loss based on the first to third feature vectors, and update the non-semantic feature extractor model based on the emotion classification loss and the similarity loss.

The at least one processor may be further configured to: input the first feature vector and the second feature vector into an emotion classifier and acquire a first predicted emotion corresponding to the first feature vector and a second predicted emotion corresponding to the second feature vector, acquire the emotion classification loss based on the first predicted emotion, the second predicted emotion, and a first true emotion corresponding to the first sample user voice, and update the emotion classifier based on a weight corresponding to the emotion classification loss.

The first predicted emotion and the second predicted emotion may be identical.

The at least one processor may be further configured to: acquire the similarity loss based on distance information among the first to third feature vectors, and update the non-semantic feature extractor model based on a weight corresponding to an aggregation of the emotion classification loss and the similarity loss.

The at least one processor may be further configured to: transfer train the synthetic voice classifier model based on the non-semantic feature extractor model and a loss function.

The at least one processor may be configured to: input a plurality of sample voice data into the non-semantic feature extractor model, and acquire non-semantic features corresponding to the plurality of sample voice data, and input the non-semantic features corresponding to the plurality of sample voice data into the synthetic voice classifier model, and acquire a prediction result that each of the plurality of sample voice data is classified into the synthetic voice or the user voice, acquire a cross entropy loss corresponding to the prediction result and a true result based on the loss function, and update the synthetic voice classifier model based on the cross entropy loss.

The plurality of sample voice data may include a plurality of sample user voices and a plurality of sample synthetic voices, and the true result may be a result of classifying each of the plurality of sample voice data into the synthetic voice or the user voice based on true labels corresponding to the plurality of sample voice data.

The synthetic voice classifier model may be further configured to: output a probability that the voice data is included in the synthetic voice, and the at least one processor may be further configured to: based on the probability exceeding a threshold probability, classify the voice data as the synthetic voice.

The at least one processor may be further configured to: adjust the threshold probability based on a security level corresponding to an application that is being executed in the electronic device, and based on the voice data being classified as the synthetic voice, provide a notification.

The non-semantic feature may include a feature vector corresponding to the voice data, and the at least one processor may be further configured to: input the feature vector into an emotion classifier and acquire a predicted emotion corresponding to the feature vector, and provide a feedback corresponding to the predicted emotion.

According to an embodiment of the disclosure, a control method of an electronic device may include the steps of inputting voice data into a non-semantic feature extractor model and acquiring a non-semantic feature included in the voice data using the non-semantic feature extractor model, inputting the non-semantic feature into a synthetic voice classifier model and classifying the voice data into a synthetic voice or a user voice using the synthetic voice classifier model, and providing a result of the classification.

The non-semantic feature may include a feature vector corresponding to the voice data, and the control method may further include acquiring a first sample user voice and a second sample user voice among a plurality of sample user voices, acquiring a first segmentation voice and a second segmentation voice from the first sample user voice, acquiring a third segmentation voice from the second sample user voice, inputting each of the first to third segmentation voices into the non-semantic feature extractor model, and acquiring first to third feature vectors corresponding to each of the first to third segmentation voices, acquiring an emotion classification loss and a similarity loss based on the first to third feature vectors, and updating the non-semantic feature extractor model based on the emotion classification loss and the similarity loss.

The acquiring the emotion classification loss and the similarity loss may further include inputting the first feature vector and the second feature vector into an emotion classifier and acquiring a first predicted emotion corresponding to the first feature vector and a second predicted emotion corresponding to the second feature vector, acquiring the emotion classification loss based on the first predicted emotion, the second predicted emotion, and a first true emotion corresponding to the first sample user voice, and updating the emotion classifier based on a weight corresponding to the emotion classification loss.

The first predicted emotion and the second predicted emotion may be identical.

The control method may further include acquiring the similarity loss based on distance information among the first to third feature vectors, and updating the non-semantic feature extractor model based on a weight corresponding to an aggregation of the emotion classification loss and the similarity loss.

The control method may further include outputting a probability that the voice data is included in the synthetic voice, and based on the probability exceeding a threshold probability, the voice data may be classified as the synthetic voice.

The control method may further include adjusting the threshold probability based on a security level corresponding to an application that is being executed in the electronic device, and based on the voice data being classified as the synthetic voice, providing a notification.

The non-semantic feature may include a feature vector corresponding to the voice data, and the control method further include inputting the feature vector into an emotion classifier and acquire a predicted emotion corresponding to the feature vector, and providing a feedback corresponding to the predicted emotion.

According to an embodiment of the disclosure, provided is a non-transitory computer-readable medium storing a program for executing a control method of an electronic device, and the control method includes the steps of inputting voice data into a non-semantic feature extractor model and acquiring a non-semantic feature included in the voice data using the non-semantic feature extractor model, inputting the non-semantic feature into a synthetic voice classifier model and classifying the voice data into a synthetic voice or a user voice using the synthetic voice classifier model, and providing a result of the classification.

According to the present disclosure, a method for identifying deepfake voices and preventing damage is provided.

According to the present disclosure, an electronic device for inputting a feature vector output by a non-semantic feature extractor model into an emotion classifier and predicting the emotion of a user who uttered a user voice is provided.

### BRIEF DESCRIPTION OF THE DRAWINGS

The above and other aspects, features, and advantages of certain embodiments of the present disclosure will be more apparent from the following description taken in conjunction with the accompanying drawings.

FIG. 1 is a diagram for illustrating an electronic device generating a synthetic voice according to an embodiment of the disclosure;

FIG. 2 is a diagram for illustrating a synthetic voice and a user voice according to an embodiment of the disclosure;

FIG. 3 is a block diagram for illustrating a configuration of an electronic device according to an embodiment of the disclosure;

FIG. 4 is a diagram for illustrating a non-semantic feature extractor model and a synthetic voice classifier model according to an embodiment of the disclosure;

FIG. 5 is a diagram for illustrating learning of a non-semantic feature extractor model according to an embodiment of the disclosure;

FIG. 6 is a diagram for illustrating in detail learning of a non-semantic feature extractor model according to an embodiment of the disclosure;

FIG. 7 is a diagram for illustrating learning of a synthetic voice classifier model according to an embodiment of the disclosure;

FIG. 8 is a diagram for illustrating in detail learning of a synthetic voice classifier model according to an embodiment of the disclosure;

FIG. 9 is a diagram for illustrating a method for a synthetic voice classifier model to identify whether a voice is real or fake according to an embodiment of the disclosure;

FIG. 10 is a diagram for illustrating a method for a synthetic voice classifier model to identify whether a voice is real or fake according to an embodiment of the disclosure;

FIG. 11 is a diagram for illustrating effects according to using a non-semantic feature extractor model and a synthetic voice classifier model according to an embodiment of the disclosure; and

FIG. 12 is a flow chart for illustrating a control method of an electronic device according to an embodiment of the disclosure.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

In addition, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, as long as they do not obviously mean differently in the context. In addition, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. Also, a plurality of “modules” or a plurality of “parts” may be integrated into at least one module and implemented as at least one processor (not shown), except “a module” or “a part” that needs to be implemented as specific hardware.

In addition, in this specification, the term “user” may refer to a person who uses an electronic device or a device using an electronic device (e.g.: an artificial intelligence electronic device).

Hereinafter, embodiments of the disclosure will be described in more detail with reference to the accompanying drawings.

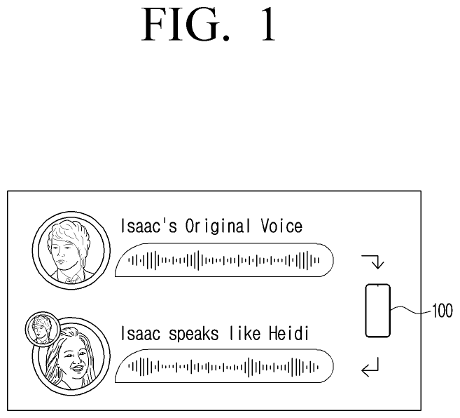

FIG. 1 is a diagram for illustrating an electronic device generating a synthetic voice according to an embodiment of the disclosure.

An electronic device 100 according to an embodiment of the disclosure may generate a synthetic voice, and also identify whether voice data is a synthetic voice.

Here, the synthetic voice includes a voice generated by the electronic device 100, e.g., a voice generated by the electronic device 100 by using a neural network model. Here, if an original voice (e.g., a voice uttered by a user (the male user Isaac in FIG. 1) of the electronic device 100) (referred to as a user voice hereinafter) or a text is input, the neural network model may be a model trained to synthesize the user voice or the text based on the voice feature information of a user (e.g., the female user Heidi in FIG. 1) (referred to as a user for synthesis hereinafter) to which the user voice or the text is to be synthesized (or, to be modulated), and then output the synthetic voice.

That is, a synthetic voice is a voice imitating the voice of a user for synthesis, and it may be referred to as a deepfake voice, a modulated voice, an imitating voice, etc., but it will be generally referred to as a synthetic voice for the convenience of explanation.

Here, the voice feature information includes a part of the voice uttered by the user for synthesis, the utterance frequency (or, the waveform) of the user for synthesis, the sex, the age (e.g., young age, middle age, old age, etc.), the language used, etc. Also, the neural network model may be a model that was trained to output a synthetic voice similar to the voice actually uttered by the user for synthesis based on the voice feature information.

Meanwhile, a person's voice, i.e., a voiceprint is a unique feature that is different for every person, and thus a person can be specified by using a voice, and the voice is used in an authentication process related to security, and thus there is a possibility that a synthetic voice uttered by the neural network model may be used maliciously. For example, there is a possibility that a synthetic voice may be misused in an authentication process or a fraud (e.g., voice phishing, referred to as vishing hereinafter) process of deceiving another person by imitating the voice of the user for synthesis through the neural network model.

Hereinafter, a method for the electronic device 100 to acquire voice data, and identify whether the acquired voice data is a synthetic voice or a user voice according to the various embodiments of the disclosure will be described.

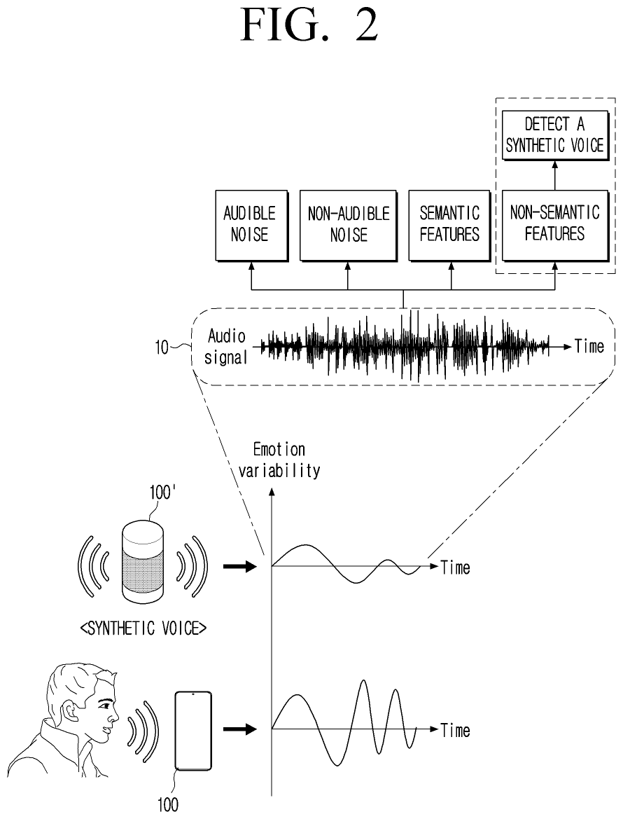

FIG. 2 is a diagram for illustrating a synthetic voice and a user voice according to an embodiment of the disclosure.

Referring to FIG. 2, a synthetic voice has small variability of emotion according to time compared to a voice uttered by the user of the electronic device 100, i.e., a user voice.

For example, the voice data 10 may include noises (audible noises and non-audible noises), and semantic features and non-semantic features.

Here, the semantic features may include phonetic features and lexical features included in a voice for delivering meaning.

According to an embodiment of the disclosure, the non-semantic features may include remaining features excluding the semantic features in a voice, e.g., the speaker identity, the language, the emotional features, the prosodic features, etc. included in the voice, although they do not deliver meaning. For example, the non-semantic features have correlation with the speaker's emotion and prosody, and the emotion of the speaker can be predicted based on the non-semantic features. Detailed explanation in this regard will be provided later.

Also, according to an embodiment of the disclosure, the non-semantic features do not change drastically according to passage of time compared to the semantic features (e.g., the non-semantic features change more slowly compared to the semantic features).

The electronic device 100 according to an embodiment of the disclosure may acquire the non-semantic features from the voice data 10, and classify the voice data 10 into a synthetic voice or a user voice (i.e., a non-synthetic voice) based on the non-semantic features. Detailed explanation in this regard will be described later.

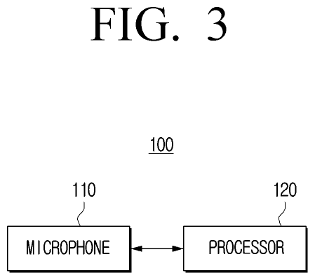

FIG. 3 is a block diagram for illustrating a configuration of an electronic device according to an embodiment of the disclosure.

Referring to FIG. 3, the electronic device 100 includes a microphone 110 and a processor 120.

The processor 120 may include one processor or a plurality of processors. In the various embodiments of the disclosure, it is assumed that the electronic device 100 is a user terminal device for the convenience of explanation. However, this is merely an example, and the electronic device 100 may include at least one of a TV, a user terminal device, a tablet PC, a mobile phone, a video phone, an e-book reader, a desktop PC, a laptop PC, a netbook computer, a workstation, a server, a PDA, a portable multimedia player (PMP), an MP3 player, a medical device, a camera, a virtual reality (VR) implementation device, or a wearable device. Here, a wearable device may include at least one of an accessory-type device (e.g., a watch, a ring, a bracelet, an ankle bracelet, a necklace, glasses, a contact lens, or a head-mounted-device (HMD)), a device integrated with fabrics or clothing (e.g., electronic clothing), a body-attached device (e.g., a skin pad or a tattoo), or an implantable circuit. Also, in some embodiments, the electronic device 100 may include at least one of a TV, a digital video disk (DVD) player, an audio, a refrigerator, an air conditioner, a cleaner, an oven, a microwave oven, a washing machine, an air purifier, a source device (e.g., a set-top box, a cloud server, an OTT service (an over-the-top media service) server, etc.), a home automation control panel, a security control panel, a media box (e.g., Apple TV™ or Google TV™), an LED S-Box, a game console (e.g., Xbox™, PlayStation™, Nintendo Switch™), an electronic dictionary, an electronic key, a camcorder, or an electronic photo frame.

In other embodiments, the electronic device 100 may include at least one of various types of medical instruments (e.g., various types of portable medical measurement instruments (a blood glucose meter, a heart rate meter, a blood pressure meter, or a thermometer, etc.), magnetic resonance angiography (MRA), magnetic resonance imaging (MRI), computed tomography (CT), a photographing device, or an ultrasonic instrument, etc.), a navigation device, a global navigation satellite system (GNSS), an event data recorder (EDR), a flight data recorder (FDR), a vehicle infotainment device, electronic equipment for vessels (e.g., a navigation device for vessels, a gyrocompass, etc.), avionics, a security device, a head unit for vehicles, an industrial or a household robot, a drone, an ATM of a financial institution, a point of sales (POS) of a store, or an Internet of Things (IOT) device (e.g., a light bulb, various types of sensors, a sprinkler device, a fire alarm, a thermostat, a street light, a toaster, exercise equipment, a hot water tank, a heater, a boiler, etc.).

The microphone 110 according to an embodiment may receive the voice data 10 including voices and noises generated around the electronic device 100 and convert the voice data 10 into an electronic signal, and transmit the signal to the processor 120. Meanwhile, in the various embodiments of the disclosure, a case where the voice data 10 is received through the microphone 110 was assumed, but this is merely an example, and the disclosure is not limited thereto. For example, the electronic device 100 can obviously receive the voice data 10 from another electronic device through a communication interface (not shown).

The processor 120 according to an embodiment of the disclosure controls the overall operations of the electronic device 100.

According to an embodiment of the disclosure, the processor 120 may be implemented as a digital signal processor (DSP) processing digital signals, a microprocessor, and a timing controller (TCON). However, the disclosure is not limited thereto, and the at least one processor 120 may include one or more of a central processing unit (CPU), a micro controller unit (MCU), a micro processing unit (MPU), a controller, an application processor (AP) or a communication processor (CP), an ARM processor, and an artificial intelligence (AI) processor, or may be defined by the terms. Also, the processor 120 may be implemented as a system on chip (SoC) having a processing algorithm stored therein or large scale integration (LSI), or implemented in the form of a field programmable gate array (FPGA). The processor 120 may perform various functions by executing computer executable instructions stored in the memory.

Also, the processor 120 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The processor 120 may control one or a random combination of the other components of the electronic device, and perform an operation related to communication or data processing. Further, the processor 120 may execute one or more programs or instructions stored in the memory. For example, the processor 120 may perform the method according to an embodiment of the disclosure by executing at least one instruction stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The processor 120 may be implemented as a single core processor including one core, or it may be implemented as one or more multicore processors including a plurality of cores (e.g., multicores of the same kind or multicores of different kinds). In case the processor 120 is implemented as multicore processors, each of the plurality of cores included in the multicore processors may include an internal memory of the processor such as a cache memory, an on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) where at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

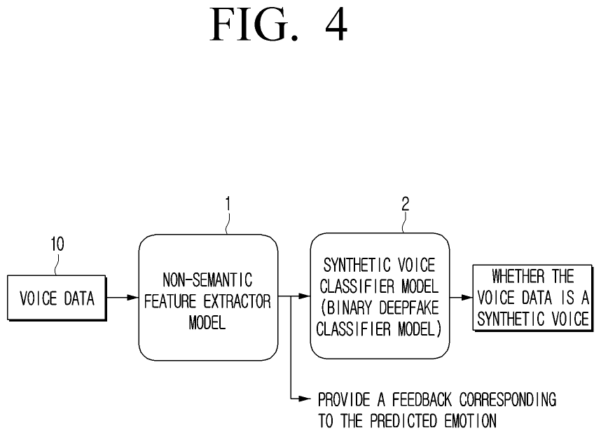

FIG. 4 is a diagram for illustrating a non-semantic feature extractor model and a synthetic voice classifier model according to an embodiment of the disclosure.

First, the processor 120 may input the voice data 10 into a non-semantic feature extractor model 1, and acquire non-semantic features included in the voice data 10. The processor 120 may provide a feedback corresponding to a predicted emotion using the non-semantic features.

Here, the non-semantic feature extractor model 1 may be implemented as a convolutional neural network (CNN), a Transformer, a CNN+a recurrent neural network (RNN), a CNN+a Transformer, etc. Here, the CNN may be implemented as a ResNet (e.g., ResNet-50), a MobileNet (e.g., MobileNet-V3), an EfficientNet, an Inception, etc.

Then, the processor 120 may input the non-semantic features into a synthetic voice classifier model 2, and classify the voice data into any one of a synthetic voice or a user voice using the synthetic voice classifier model 2. Then, the processor 120 may provide the classification result.

Here, the synthetic voice classifier model 2 may be a model that is transfer-learned based on the non-semantic feature extractor model 1.

The synthetic voice classifier model 2 may be implemented as various types of binary classification models.

For example, the synthetic voice classifier model 2 may be implemented as a logistic regression, a support vector machine classifier, tree models, boosting models, a multilayer perception (MLP), a fully connected neural network (FCNN), etc. For example, the synthetic voice classifier model 2 according to an embodiment of the disclosure may be implemented as a fully connected neural network trained by using Adam and a cross entropy loss, and an ReLU activation function.

Here, Adam is an example of optimization algorithms, and optimization algorithms are not limited thereto. For example, each of the non-semantic feature extractor model 1 and the synthetic voice classifier model 2 may be trained by using various types of optimization algorithms based on a gradient descent (e.g., Adam, AdaGrad, Nesterov's Accelerated Gradient and Momentum (NAG)).

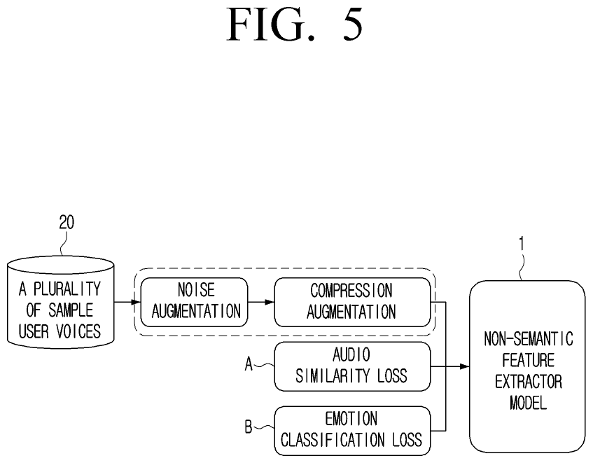

FIG. 5 is a diagram for illustrating learning of a non-semantic feature extractor model according to an embodiment of the disclosure.

Referring to FIG. 5, the processor 120 may pre-process (or, regularize) each of a plurality of sample user voices 20.

For example, the processor 120 may perform noise injection (or, noise augmentation) and compression augmentation to each of the plurality of sample user voices 20, and thereby perform data augmentation for each of the plurality of sample user voices 20.

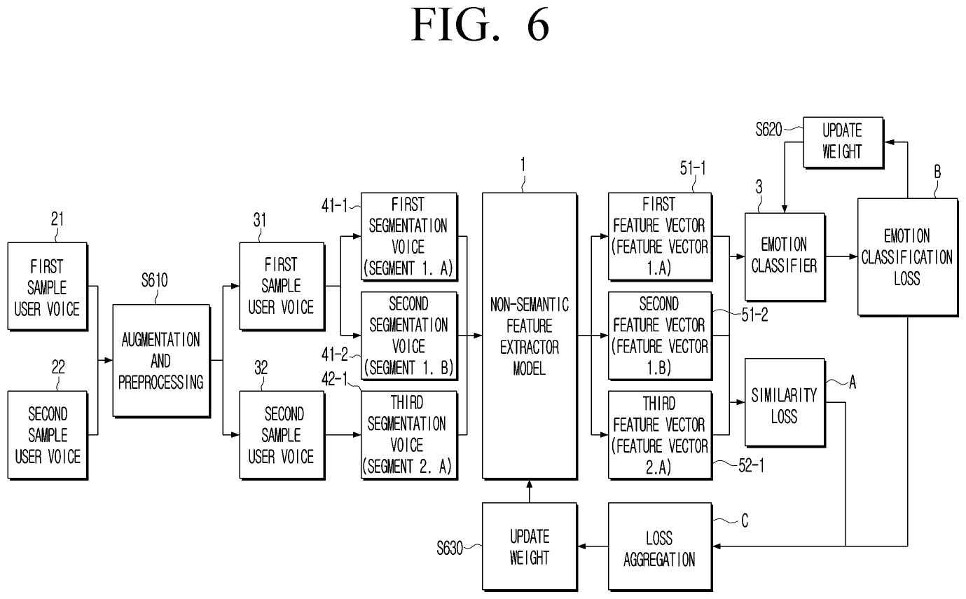

Then, the processor 120 may train the non-semantic feature extractor model 1 based on the plurality of pre-processed sample user voices 20, a similarity loss A and an emotion classification loss B. The method of training the non-semantic feature extractor model 1 will be described in more detail with reference to FIG. 6.

FIG. 6 is a diagram for illustrating in detail learning of a non-semantic feature extractor model according to an embodiment of the disclosure.

The processor 120 according to an embodiment of the disclosure may acquire a first sample user voice 21 and a second sample user voice 22 among the plurality of sample user voices 20.

Then, the processor 120 may augment and pre-process each of the first sample user voice 21 and the second sample user voice 22 in operation S610.

Then, the processor 120 may acquire a first segmentation voice 41-1 and a second segmentation voice 41-2 in the pre-processed first sample user voice 31. Also, the processor 120 may acquire a third segmentation voice 42-1 from the pre-processed second sample user voice 32.

The processor 120 according to an embodiment may input the first segmentation voice 41-1, the second segmentation voice 41-2, and the third segmentation voice 42-1 into the non-semantic feature extractor model 1, and the non-semantic feature extractor model 1 may output a first feature vector 51-1, a second feature vector 51-2, and a third feature vector 52-1 corresponding to the first segmentation voice 41-1, the second segmentation voice 41-2, and the third segmentation voice 42-1, respectively.

As an example, the non-semantic feature extractor model 1 may perform an embedding process of digitizing the non-semantic features including the speaker identity, the language, the emotional feature, the prosodic feature, etc. in the input voice (or, the input segmentation voice), and expressing the non-semantic features in a vector space, and output a feature vector corresponding to the input voice.

Then, the processor 120 may input the first feature vector 51-1 and the second feature vector 51-2 into an emotion classifier 3.

The emotion classifier 3 according to an embodiment of the disclosure may output a first predicted emotion corresponding to the first feature vector 51-1 and a second predicted emotion corresponding to the second feature vector 51-2.

When a feature vector is input, the emotion classifier 3 according to an embodiment of the disclosure may output any one of six kinds of basic emotions defined by Paul Ekman (anger, surprise, disgust, enjoyment, fear, and sadness) as a predicted emotion corresponding to the feature vector. However, this is merely an example, and the emotion classifier 3 can obviously output any one of eight kinds of emotions (anger, surprise, disgust, enjoyment, fear, sadness, contempt, and neural) as a predicted emotion.

Meanwhile, as described above, non-semantic features change slowly, and thus the first predicted emotion corresponding to the first feature vector 51-1 and the second predicted emotion corresponding to the second feature vector 51-2 acquired from the same sample user voice (e.g., the first sample user voice 21) may be identical.

Then, the processor 120 may acquire the emotion classification loss B based on a first true emotion corresponding to the first sample user voice and the first predicted emotion and the second predicted emotion. Here, the plurality of sample user voices 20 may include true emotions corresponding to each of the plurality of sample user voices, i.e., true labels. The processor 120 according to an embodiment of the disclosure may acquire the emotion classification loss B by using a cross entropy loss and a focal loss.

The processor 120 according to an embodiment of the disclosure may train or update the emotion classifier 3 based on a weight corresponding to the emotion classification loss B in operation S620.

Also, the at least one processor 120 according to an embodiment of the disclosure may acquire the similarity loss A based on the distance information among the first feature vector 51-1, the second feature vector 51-2, and the third feature vector 52-1.

According to an embodiment of the disclosure, the first feature vector 51-1 and the second feature vector 51-2 are feature vectors acquired from the first sample user voice 21, and thus the distance between the first feature vector 51-1 and the second feature vector 51-2 in a vector space is small. Also, as the third feature vector 52-1 is a feature vector acquired from the second sample user voice 22, each of the distance between the first feature vector 51-1 and the third feature vector 52-1 and the distance between the second feature vector 51-2 and the third feature vector 52-1 may be big.

The processor 120 according to an embodiment of the disclosure may acquire the similarity loss A by using a triple loss, a margin loss, an MSE, etc.

Then, the processor 120 may acquire a weight corresponding to an aggregation C of the similarity loss A and the emotion classification loss B, and train or update the non-semantic feature extractor model 1 based on the acquired weight in operation S630.

According to an embodiment of the disclosure, the processor 120 may acquire a predicted emotion from non-semantic features by using the emotion classification loss B, but if only the emotion classification loss B is used, there is a possibility that all voices having the same emotion (e.g., enjoyment) may be misinterpreted to have almost the same non-semantic features with one another. As an example, in a process of training the non-semantic feature extractor model 1, there is a problem that the speaker identity, the language, the prosodic feature, etc. are excluded other than the emotional features included in the non-semantic features of a voice. Accordingly, the similarity loss A other than the emotion classification loss B is also used according to an embodiment of the disclosure, and thus the speaker identity, the language, the prosodic feature, etc. included in non-semantic features may not be excluded in a process of training the non-semantic feature extractor model 1.

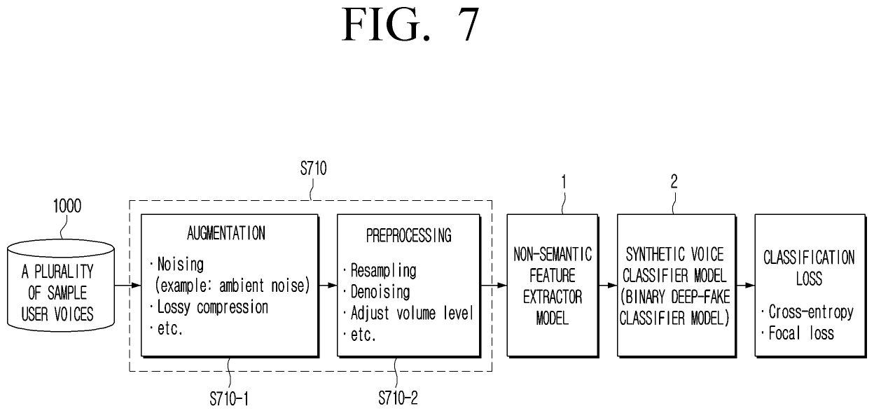

FIG. 7 is a diagram for illustrating learning of a synthetic voice classifier model according to an embodiment of the disclosure.

The synthetic voice classifier model 2 according to an embodiment of the disclosure may be a model that transfer-learned based on the non-semantic feature extractor model 1. For example, the processor 120 may transfer-train the synthetic voice classifier model 2 based on the non-semantic feature extractor model and a loss function.

First, the processor 120 may augment S710-1 and pre-process S710-2 each of the plurality of sample voice data 1000 in operation S710.

As an example, in the augmenting operation S710-1, noise injection and lossy compression may be performed for each of the plurality of sample voice data 1000, and in the pre-processing operation S710-2, resampling, denoising, and volume level adjustment may be performed for each of the plurality of augmented sample voice data.

Then, the processor 120 may input each of the plurality of pre-processed sample voice data into the non-semantic feature extractor model 1.

Then, the processor 120 may input the non-semantic features output by the non-semantic feature extractor model 1 (e.g., feature vectors corresponding to the plurality of pre-processed sample voice data) into the synthetic voice classifier model (the binary deepfake classifier model) 2.

The synthetic voice classifier model 2 according to an embodiment may classify each of the plurality of sample voice data into a synthetic voice or a user voice.

Meanwhile, the processor 120 may acquire a classification loss based on the prediction result where the synthetic voice classifier model 2 classified each of the plurality of sample voice data into a synthetic voice or a user voice and the true result, and train or update the synthetic voice classifier model 2 based on the acquired classification loss.

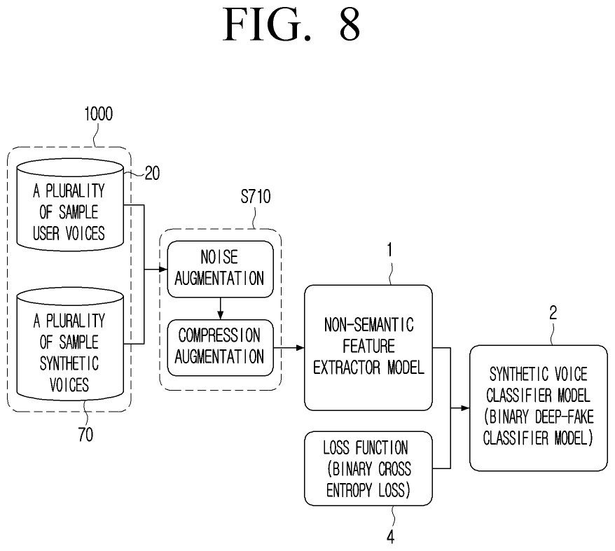

Detailed explanation in this regard will be provided with reference to FIG. 8.

FIG. 8 is a diagram for illustrating in detail learning of a synthetic voice classifier model according to an embodiment of the disclosure.

Referring to FIG. 8, the plurality of sample voice data 1000 may include a plurality of sample user voices 20 and a plurality of sample synthetic voices 70.

Also, the plurality of sample voice data 1000 may include true labels indicating that each of the plurality of sample user voices falls under a user voice, and true labels indicating that each of the plurality of sample synthetic voices falls under a synthetic voice.

The processor 120 according to an embodiment may augment and pre-process each of the plurality of sample voice data in operation S710.

Then, the processor 120 may input each of the plurality of pre-processed sample voice data into the non-semantic feature extractor model 1.

Then, the processor 120 may acquire non-semantic features (e.g., feature vectors) corresponding to the plurality of pre-processed sample voice data, and input the feature vectors corresponding to the plurality of pre-processed sample voice data into the synthetic voice classifier model 2.

Then, the synthetic voice classifier model 2 may output a prediction result where each of the plurality of sample voice data was classified into any one of a synthetic voice or a user voice based on the feature vectors corresponding to the plurality of sample voice data.

The processor 120 according to an embodiment of the disclosure may acquire a cross entropy loss corresponding to the prediction result and the true result based on a loss function 4, and train or update the synthetic voice classifier model 2 based on the cross entropy loss.

Here, the true result may include a result wherein each of the plurality of sample voice data was classified into any one of a synthetic voice or a user voice based on the true labels corresponding to the plurality of sample voice data.

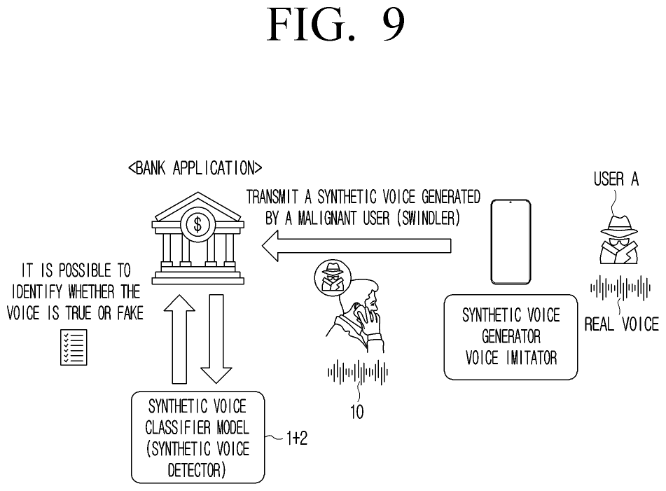

FIG. 9 is a diagram for illustrating a method for a synthetic voice classifier model to identify whether a voice is real or fake according to an embodiment of the disclosure.

Referring to FIG. 9, a conventional synthetic voice generator or a conventional voice imitator may output a synthetic voice corresponding to a user voice actually uttered by the User A (i.e., a true voice or a real voice).

A synthetic voice, i.e., the voice data 10 may be used in an authentication process related to security, and an application, a program, etc. that are being executed in the electronic device 100 according to an embodiment of the disclosure. The electronic device 100 may classify the voice data 10 into any one of a synthetic voice or a user voice by using a synthetic voice detector. Here, the synthetic voice detector may be a model including the non-semantic feature extractor model 1 and the synthetic voice classifier model 2.

If the voice data 10 is classified as a synthetic voice, the electronic device 100 according to an embodiment of the disclosure may not perform an authentication process by using the voice data 10. As another example, if the voice data 10 is classified as a user voice, the electronic device 100 may perform an authentication process by using the voice data 10.

Meanwhile, the synthetic voice classifier model 1 may output a probability that the voice data may fall under a synthetic voice. According to an embodiment, if the probability output by the synthetic voice classifier model 1 exceeds a threshold probability (e.g., 0.7), the at least one processor 120 may classify the voice data as a synthetic voice.

The processor 120 according to an embodiment may adjust the threshold probability based on a security level corresponding to an application that is being executed in the electronic device 100. For example, if the application is a bank/financial application, and the security level corresponding to the bank/financial application is the highest level, the processor 120 may lower the threshold probability (e.g., 0.7->0.5). Then, if the voice data 10 is classified as a synthetic voice, the at least one processor 120 may not perform an authentication process by using the voice data 10. Here, the specific numbers are merely an example for the convenience of explanation, and the disclosure is not limited thereto.

If the voice data 10 is classified as a synthetic voice, the at least one processor 120 according to an embodiment of the disclosure may provide a notification.

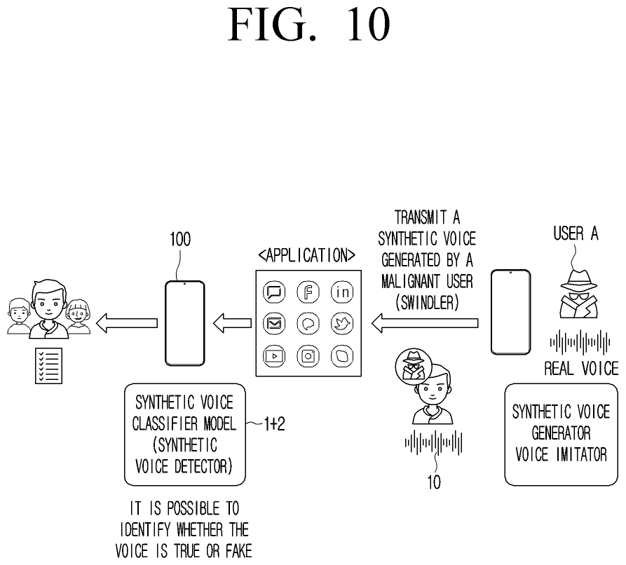

FIG. 10 is a diagram for illustrating a method for a synthetic voice classifier model to identify whether a voice is real or fake according to an embodiment of the disclosure.

Referring to FIG. 10, a conventional synthetic voice generator or a conventional voice imitator may output a synthetic voice corresponding to a user voice actually uttered by the User A (i.e., a true voice or a real voice).

According to an embodiment of the disclosure, the electronic device 100 may receive the synthetic voice, i.e., the voice data 10, and the electronic device 100 may classify the voice data 10 into any one of a synthetic voice or a user voice by using a synthetic voice detector.

Also, according to an embodiment of the disclosure, if the received voice data 10 is classified as a synthetic voice, the electronic device 100 may provide the classification result.

In addition, according to an embodiment of the disclosure, if a counterpart according to a call application (e.g., the caller (the User A)) transmits a synthetic voice by using the synthetic voice generator, the electronic device 100 may detect the synthetic voice (i.e., classify the received voice data 10 as a synthetic voice) by using the synthetic voice detector, and provide the detection result.

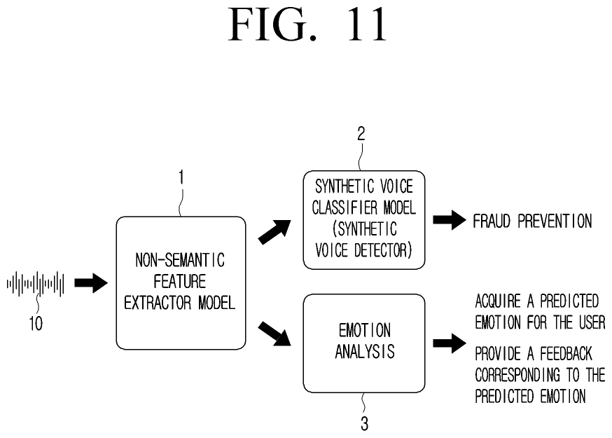

FIG. 11 is a diagram for illustrating effects of using a non-semantic feature extractor model and a synthetic voice classifier model according to an embodiment of the disclosure.

Referring to FIG. 11, the processor 120 classifies the voice data 10 into any one of a synthetic voice or a user voice by using the non-semantic feature extractor model 1 and the synthetic voice classifier model 2, and if the voice data 10 is classified as a synthetic voice, the processor 120 does not specify a person by using features that can be identified as a synthetic voice (e.g., the voiceprint), and thus occurrence of a fraud can be prevented (e.g., prevention of vishing).

Also, the processor 120 may input a feature vector output by the non-semantic feature extractor model 1 into the emotion classifier 3, and predict the emotion of a user who uttered a user voice when the voice data 10 is a user voice (i.e., acquire a predicted emotion corresponding to the feature vector).

In addition, the processor 120 may provide a feedback corresponding to the predicted emotion. For example, if the predicted emotion is anger, the at least one processor 120 may execute a music application and provide a song, and if a shopping application is being executed, the processor 120 may provide a phrase for preventing impulse buying.

Also, if the predicted emotion is enjoyment or surprise, the at least one processor 120 may execute a photo application. However, this is merely an example, and the disclosure is not limited thereto. For example, if the predicted emotion is disgust, the processor 120 may restrict execution of an SNS application.

Returning to FIG. 3, functions related to artificial intelligence models including the neural network model, the non-semantic feature extractor model 1, the synthetic voice classifier model 2, and the emotion classifier 3 according to the disclosure are operated through the processor 120 and the memory of the electronic device 100.

The processor may include one or a plurality of processors. Here, the one or plurality of processors may include at least one of a central processing unit (CPU), a graphic processing unit (GPU), or a neural processing unit (NPU), but the processors are not limited to the aforementioned examples of processors.

A CPU is a generic-purpose processor that can perform not only general operations but also artificial intelligence operations, and it can effectively execute a complex program through a multilayer cache structure. A CPU is advantageous for a serial processing method that enables a systemic linking between the previous calculation result and the next calculation result through sequential calculations. Meanwhile, a generic-purpose processor is not limited to the aforementioned examples excluding cases wherein it is specified as the aforementioned CPU.

A GPU is a processor for mass operations such as a floating point operation used for graphic processing, etc., and it can perform mass operations in parallel by massively integrating cores. In particular, a GPU may be advantageous for a parallel processing method such as a convolution operation, etc. compared to a CPU. Also, a GPU may be used as a co-processor for supplementing the function of a CPU. Meanwhile, a processor for mass operations is not limited to the aforementioned examples excluding cases wherein it is specified as the aforementioned GPU.

An NPU is a processor specialized for an artificial intelligence operation using an artificial neural network, and it can implement each layer constituting an artificial neural network as hardware (e.g., silicon). Here, the NPU is designed to be specialized according to the required specification of a company, and thus it has a lower degree of freedom compared to a CPU or a GPU, but it can effectively process an artificial intelligence operation required by the company. Meanwhile, as a processor specialized for an artificial intelligence operation, an NPU may be implemented in various forms such as a tensor processing unit (TPU), an intelligence processing unit (IPU), a vision processing unit (VPU), etc. Meanwhile, an artificial intelligence processor is not limited to the aforementioned examples excluding cases wherein it is specified as the aforementioned NPU.

Also, the one or plurality of processors may be implemented as a system on chip (SoC). Here, in the SoC, the memory, and a network interface such as a bus for data communication between the processor and the memory, etc. may be further included other than the one or plurality of processors.

In case the plurality of processors are included in the system on chip (SoC) included in the electronic device 100, the electronic device 100 may perform an operation related to artificial intelligence (e.g., an operation related to learning or inference of the artificial intelligence model) by using some processors among the plurality of processors. For example, the electronic device 100 may perform an operation related to artificial intelligence by using at least one of a GPU, an NPU, a VPU, a TPU, or a hardware accelerator specified for artificial intelligence operations such as a convolution operation, a matrix product operation, etc. among the plurality of processors. However, this is merely an example, and the electronic device 100 can obviously process an operation related to artificial intelligence by using the generic-purpose processor such as a CPU, etc.

Also, the electronic device 100 may perform operations related to artificial intelligence by using a multicore (e.g., a dual core, a quad core, etc.) included in one processor. In particular, the electronic device 100 may perform artificial intelligence operations such as a convolution operation, a matrix product operation, etc. by using the multicore included in the processor.

The one or plurality of processors perform control to process input data according to predefined operation rules or an artificial intelligence model stored in the memory. The predefined operation rules or the artificial intelligence model are characterized in that they are made through learning.

Here, being made through learning means that predefined operation rules or an artificial intelligence model having desired characteristics are made by applying a learning algorithm to a plurality of learning data. Such learning may be performed in a device itself where artificial intelligence is performed according to the disclosure, or through a separate server/system.

An artificial intelligence model may include a plurality of neural network layers. At least one layer has at least one weight value, and performs an operation of the layer through an operation result of the previous layer and at least one defined operation. As examples of a neural network, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN), deep Q-networks, and a Transformer, but the neural network in the disclosure is not limited to the aforementioned examples excluding specified cases.

A learning algorithm is a method of training a specific subject device (e.g., a robot) by using a plurality of learning data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

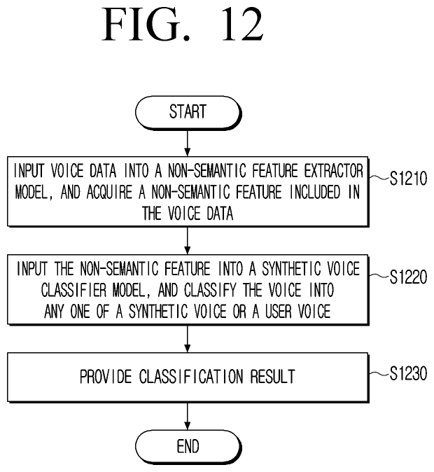

FIG. 12 is a flow chart for illustrating a control method of an electronic device according to an embodiment of the disclosure.

In a control method of an electronic device according to an embodiment of the disclosure, first, voice data is input into a non-semantic feature extractor model and a non-semantic feature included in the voice data is acquired in operation S1210.

Then, the non-semantic feature is input into a synthetic voice classifier model, and the voice data is classified into any one of a synthetic voice or a user voice in operation S1220.

Then, the classification result may be provided in operation S1230.

Here, the non-semantic feature may include a feature vector corresponding to the voice data, and the control method according to an embodiment may further include the steps of acquiring a first sample user voice and a second sample user voice among a plurality of sample user voices, acquiring a first segmentation voice and a second segmentation voice from the first sample user voice, acquiring a third segmentation voice from the second sample user voice, inputting each of the first to third segmentation voices into the non-semantic feature extractor model, and acquiring first to third feature vectors corresponding to the first to third segmentation voices, acquiring an emotion classification loss and a similarity loss based on the first to third feature vectors, and updating the non-semantic feature extractor model based on the emotion classification loss and the similarity loss.

Here, the step of acquiring the emotion classification loss and the similarity loss may further include the steps of inputting the first feature vector and the second feature vector into an emotion classifier and acquiring a first predicted emotion corresponding to the first feature vector and a second predicted emotion corresponding to the second feature vector, acquiring the emotion classification loss based on the first predicted emotion, the second predicted emotion, and a first true emotion corresponding to the first sample user voice, and updating the emotion classifier based on a weight corresponding to the emotion classification loss.

Here, the first predicted emotion and the second predicted emotion may be identical.

The step of acquiring the emotion classification loss and the similarity loss according to an embodiment of the disclosure may include the step of acquiring the similarity loss based on distance information among the first to third feature vectors, and the step of updating may include the step of updating the non-semantic feature extractor model based on a weight corresponding to an aggregation of the emotion classification loss and the similarity loss.

The control method according to an embodiment of the disclosure may further include the step of transfer-training the synthetic voice classifier model based on the non-semantic feature extractor model and a loss function.

Here, the step of training may include the steps of inputting a plurality of sample voice data into the non-semantic feature extractor model, and acquiring non-semantic features corresponding to each of the plurality of sample voice data, inputting the non-semantic features corresponding to each of the plurality of sample voice data into the synthetic voice classifier model, and acquiring a prediction result that classified each of the plurality of sample voice data into any one of the synthetic voice or the user voice, acquiring a cross entropy loss corresponding to the prediction result and a true result based on the loss function, and updating the synthetic voice classifier model based on the cross entropy loss.

The plurality of sample voice data according to an embodiment of the disclosure may include a plurality of sample user voices and a plurality of sample synthetic voices, and the true result may be a result of classifying each of the plurality of sample voice data into the synthetic voice or the user voice based on true labels corresponding to each of the plurality of sample voice data.

The synthetic voice classifier model according to an embodiment of the disclosure may output a probability that the voice data is included in the synthetic voice, and the classifying operation S1220 may include the step of, based on the probability exceeding a threshold probability, classifying the voice data as the synthetic voice.

Meanwhile, the various embodiments of the disclosure can obviously be applied not only to an electronic device, but also to all types of electronic devices that can receive voice data.

Meanwhile, the aforementioned various embodiments may be implemented in a recording medium that can be read by a computer or a device similar to a computer, by using software, hardware, or a combination thereof. In some cases, the embodiments described in this specification may be implemented as the processor itself. According to implementation by software, the embodiments such as procedures and functions described in this specification may be implemented as separate software modules. Each of the software modules can perform one or more functions and operations described in this specification.

Meanwhile, computer instructions for performing processing operations of the electronic device according to the aforementioned various embodiments of the disclosure may be stored in a non-transitory computer-readable medium. Computer instructions stored in such a non-transitory computer-readable medium make the processing operations at the electronic device 100 according to the aforementioned various embodiments performed by a specific machine, when the instructions are executed by the processor of the specific machine.

A non-transitory computer-readable medium refers to a medium that stores data semi-permanently, and is readable by machines, but not a medium that stores data for a short moment such as a register, a cache, and a memory. As specific examples of a non-transitory computer-readable medium, there may be a CD, a DVD, a hard disc, a blue-ray disc, a USB, a memory card, a ROM and the like.

Also, while specific embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device comprising:
a microphone; and
at least one processor configured to:
based on receiving voice data through the microphone, input the voice data into a non-semantic feature extractor model and acquire a non-semantic feature included in the voice data using the non-semantic feature extractor model,
input the non-semantic feature into a synthetic voice classifier model, and classify the voice data into a synthetic voice or a user voice using the synthetic voice classifier model, and
provide a result of the classification,
wherein the synthetic voice classifier model is a model that is transfer-learned based on the non-semantic feature extractor model.

2. The electronic device of claim 1, wherein the non-semantic feature comprises a feature vector corresponding to the voice data, and
wherein the at least one processor is further configured to:
acquire a first sample user voice and a second sample user voice among a plurality of sample user voices,
acquire a first segmentation voice and a second segmentation voice from the first sample user voice,
acquire a third segmentation voice from the second sample user voice,
input each of the first to third segmentation voices into the non-semantic feature extractor model, and acquire first to third feature vectors corresponding to the first to third segmentation voices,
acquire an emotion classification loss and a similarity loss based on the first to third feature vectors, and
update the non-semantic feature extractor model based on the emotion classification loss and the similarity loss.

3. The electronic device of claim 2, wherein the at least one processor is further configured to:
input the first feature vector and the second feature vector into an emotion classifier and acquire a first predicted emotion corresponding to the first feature vector and a second predicted emotion corresponding to the second feature vector,
acquire the emotion classification loss based on the first predicted emotion, the second predicted emotion, and a first true emotion corresponding to the first sample user voice, and
update the emotion classifier based on a weight corresponding to the emotion classification loss.

4. The electronic device of claim 3, wherein the first predicted emotion and the second predicted emotion are identical.

5. The electronic device of claim 2, wherein the at least one processor is further configured to:
acquire the similarity loss based on distance information among the first to third feature vectors, and
update the non-semantic feature extractor model based on a weight corresponding to an aggregation of the emotion classification loss and the similarity loss.

6. The electronic device of claim 1, wherein the at least one processor is further configured to:
transfer train the synthetic voice classifier model based on the non-semantic feature extractor model and a loss function.

7. The electronic device of claim 6, wherein the at least one processor is further configured to:
input a plurality of sample voice data into the non-semantic feature extractor model, and acquire non-semantic features corresponding to the plurality of sample voice data, and
input the non-semantic features corresponding to the plurality of sample voice data into the synthetic voice classifier model, and acquire a prediction result that each of the plurality of sample voice data is classified into the synthetic voice or the user voice,
acquire a cross entropy loss corresponding to the prediction result and a true result based on the loss function, and
update the synthetic voice classifier model based on the cross entropy loss.

8. The electronic device of claim 7, wherein the plurality of sample voice data comprise:
a plurality of sample user voices and a plurality of sample synthetic voices, and
wherein the true result is a result of classifying each of the plurality of sample voice data into the synthetic voice or the user voice based on true labels corresponding to the plurality of sample voice data.

9. The electronic device of claim 1, wherein the synthetic voice classifier model is further configured to:
output a probability that the voice data is included in the synthetic voice, and
wherein the at least one processor is further configured to:
based on the probability exceeding a threshold probability, classify the voice data as the synthetic voice.

10. The electronic device of claim 9, wherein the at least one processor is further configured to:
adjust the threshold probability based on a security level corresponding to an application that is being executed in the electronic device, and
based on the voice data being classified as the synthetic voice, provide a notification.

11. The electronic device of claim 1, wherein the non-semantic feature comprises a feature vector corresponding to the voice data, and
wherein the at least one processor is further configured to:
input the feature vector into an emotion classifier and acquire a predicted emotion corresponding to the feature vector, and
provide a feedback corresponding to the predicted emotion.

12. A control method of an electronic device, the method comprising:
inputting voice data into a non-semantic feature extractor model and acquiring a non-semantic feature included in the voice data using the non-semantic feature extractor model;
inputting the non-semantic feature into a synthetic voice classifier model and classifying the voice data into a synthetic voice or a user voice using the synthetic voice classifier model; and
providing a result of the classification.

13. The control method of claim 12, wherein the non-semantic feature comprises a feature vector corresponding to the voice data, and
wherein the control method further comprises:
acquiring a first sample user voice and a second sample user voice among a plurality of sample user voices;
acquiring a first segmentation voice and a second segmentation voice from the first sample user voice;
acquiring a third segmentation voice from the second sample user voice;
inputting each of the first to third segmentation voices into the non-semantic feature extractor model, and acquiring first to third feature vectors corresponding to each of the first to third segmentation voices;
acquiring an emotion classification loss and a similarity loss based on the first to third feature vectors; and
updating the non-semantic feature extractor model based on the emotion classification loss and the similarity loss.

14. The control method of claim 13, wherein the acquiring the emotion classification loss and the similarity loss further comprises:
inputting the first feature vector and the second feature vector into an emotion classifier and acquiring a first predicted emotion corresponding to the first feature vector and a second predicted emotion corresponding to the second feature vector;
acquiring the emotion classification loss based on the first predicted emotion, the second predicted emotion, and a first true emotion corresponding to the first sample user voice; and
updating the emotion classifier based on a weight corresponding to the emotion classification loss.

15. The control method of claim 14, wherein the first predicted emotion and the second predicted emotion are identical.

16. The control method of claim 13, further comprising:
acquiring the similarity loss based on distance information among the first to third feature vectors, and
updating the non-semantic feature extractor model based on a weight corresponding to an aggregation of the emotion classification loss and the similarity loss.

17. The control method of claim 12, further comprising outputting a probability that the voice data is included in the synthetic voice, and
wherein based on the probability exceeding a threshold probability, the voice data is classified as the synthetic voice.

18. The control method of claim 17, further comprising:
adjusting the threshold probability based on a security level corresponding to an application that is being executed in the electronic device, and
based on the voice data being classified as the synthetic voice, providing a notification.

19. The control method of claim 12, wherein the non-semantic feature includes a feature vector corresponding to the voice data, and
wherein the control method further comprises:
inputting the feature vector into an emotion classifier and acquire a predicted emotion corresponding to the feature vector, and
providing a feedback corresponding to the predicted emotion.

20. A non-transitory computer-readable medium storing a program for executing a control method of an electronic device, the method comprising:
inputting voice data into a non-semantic feature extractor model and acquiring a non-semantic feature included in the voice data using the non-semantic feature extractor model;
inputting the non-semantic feature into a synthetic voice classifier model and classifying the voice data into a synthetic voice or a user voice using the synthetic voice classifier model; and
providing a result of the classification.
